(19) United States
(12) Patent Application Publication
(10) Pub. No.: US 2008/0188590 A1
(43) Pub. Date: Aug. 7, 2008

(54) Fire retardant body and methods of use

(76) Inventor: Laxmi C. Gupta, Los Alamitos, CA (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 12/001,795

(22) Filed: Dec. 12, 2007

Related U.S. Application Data
(60) Provisional application No. 60/874,661, filed on Dec. 13, 2006.

(51) Int. Cl. C09K 21/00

(52) U.S. Cl. 523/179

(57) ABSTRACT

A fire retardant body comprises a polymeric matrix and a non-halogenated fire retardant component that is an intumescent material. The fire retardant component is present in the fire retardant body in an amount from about 55% to about 95% of the body by weight. The body preferably has a thickness of at least about 3 mm in each dimension. Methods of using the fire retardant body for protecting a substrate from fire damage are also provided.

### CROSS-REFERENCE TO RELATED APPLICATIONS

This application claims the benefit of U.S. Provisional Application Ser. No. 60/874,661 filed Dec. 13, 2006, entitled “FIRE RETARDANT BODY AND METHODS OF USE” which application is incorporated herein by reference in its entirety.

### FIELD OF INVENTION

The present invention relates to fire retardant bodies and related methods and uses of such fire retardant bodies.

### BACKGROUND OF THE INVENTION

On Sep. 11, 2001, terrorists piloted commercial aircraft into the Twin Towers of the World Trade Center in New York and into the Pentagon in Washington DC. Incredible structural damage was experienced, as fires fueled by jet fuel burned out of control. The heat from these fires damaged structural elements of the building, possibly leading to the failure of the buildings themselves. This tragic event highlighted the need for need for new and improved fire retardant systems that can provide superior fire protection to building structures, whether the fire originates from conventional accidents or due to the actions of others.

Fire retardants are well-known and are typically added to and/or applied as a surface treatment to help prevent the spread of fire and/or protect a material exposed to fire. Commercially available fire retardants may be obtained in great variety, including examples such as bromine-based fire retardants, phosphorous-based fire retardants (e.g., ammonium polyphosphate (APP)), nitrogen-based fire retardants (e.g., melamine), inorganic-based fire retardants, and chlorine-based fire retardants.

A fire retardant can also be classified by the mechanism in which it acts as a fire retardant. For example, a class of fire retardants acts by absorbing heat, thereby cooling the surrounding material. Examples of cooling fire retardant materials are aluminum hydroxide and magnesium hydroxide. Another class of flame material operates by release of gas that interferes with the flame. Examples of this class are the halogens, such as bromine and chlorine. These materials raise potential concerns because of the potential health effects of the released gasses.

Another class of flame retardants use the mechanism known as “intumescence,”and is attributable to the fire retardant category known as “intumescents.” Intumescent fire retardants expand and form a char layer as a barrier between the underlying material and surrounding environment. This char layer is hard to burn, and insulates and protects the underlining material from burning. Intumescents operate by expansion either as a result of a chemical reaction under heat, or as by a primarily physical reaction that occurs due to the configuration of components in the intumescent material. Examples of chemical intumescents include phosphate-based materials and silica gel/potassium carbonate mixtures. Examples of physical intumescents include expandable graphite.

There is a continuing need for new and improved fire retardant systems that can provide superior fire protection to structures.

### SUMMARY OF THE INVENTION

The present invention provides a fire retardant body that provides superior protection against potentially devastating fire situations in building construction and in other environments where fire and excessive heat that would lead to fire is a concern.

The fire retardant body comprises a polymeric matrix comprising a non-halogenated fire retardant component that is an intumescent material. The fire retardant component is present in the fire retardant body in an amount from about 55% to about 95% of the body by weight. The fire retardant body preferably has a thickness of at least about 3 mm in each dimension.

In an embodiment of the present invention, the fire retardant body is a physical support structure or a useful article. In another embodiment of the present invention, the fire retardant body is provided as a cushioning, thermally insulative, and/or electrically insulative layer on or surrounding a material or device to be so protected.

The present fire retardant body provides exceptional protection from damage caused by very intense fire situations, particularly those that exceed normal fire risks. This unique fire protection is afforded due to the unique material selection, configuration and high loading of intumescent fire retardant. In particular, the use of intumescent fire retardant in such high loadings provides a material that generates a unique char structure that protects underlying materials, keeping such protected locations relatively cool. Additionally, the smoke generated in fire situations in burning of the present fire retardant body is relatively non toxic. Significantly, far less smoke is generated during the burning of the present fire retardant body as compared to burning of other materials.

In an aspect of the present invention, the present fire retardant body as part of or in support of building infrastructure provides protection in particular to structural components and spaces to be protected from fire. As a result of the performance of the present fire retardant body, critical damage to structures can be delayed or avoided, potentially saving lives and property from complete destruction from aggressive fire and/or blast damage. This level of protection was not previously achievable through conventional fire retardant usages. Additionally, because the present fire retardant body is prepared from a polymeric matrix, the resulting material has superior strength, durability and weight characteristics as compared to ceramic tiles or many other material constructions that are fire retardant.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

The fire retardant body comprises a non-halogenated fire retardant component that is an intumescent material. As noted above and for purposes of the present invention, an intumescent fire retardant is a material that expands and forms a char layer as a barrier between the underlying material and surrounding environment. In one embodiment of the present invention, the fire retardant component is a material that expands as a result of a chemical reaction under heat. In another embodiment of the present invention, the fire retardant component is a material that expands as a result of a primarily physical reaction that occurs due to the configuration of components in the intumescent material.

The chemically based intumescents generally comprise ingredients that serve three different functions: a charring agent to provide carbon for forming the char; a so called catalyst, drying agent or acid source to promote formation of the char from the carbon source; and a blowing agent or gas source to expand the char. These functions may be carried out by three separate ingredients, or by a single ingredient that can perform more than one function. In one embodiment, the preferred fire retardant component comprises ingredients selected from the group consisting of phosphate-based materials and silica gel/potassium carbonate mixtures.

Preferably, the fire retardant component comprises a phosphate-based compound. Particularly preferred fire retardant components comprise phosphorus containing compounds, such as tris(2,3-dibromopropyl)phosphate and other phosphate esters and the polyphosphates, preferably ammonium polyphosphate (“APP”). APP and methods of making APP are well known as described in, e.g., U.S. Pat. Nos. 5,165,904 (Staffel et al.), 5,277,887 (Staffel et al.), and 5,213,783 (Fukumura et al.), the disclosures of which are incorporated herein by reference.

The fire retardant component optionally can be pre-encapsulated, and preferably is encapsulated with an encapsulation material that additionally functions in support of fire retardancy. Examples of functional encapsulation materials include charring agents such as starch, dextrin, sorbitol pentaerythritol, phenol-formaldehyde resins or methylol melamine encapsulation materials, or the like. Particularly preferred fire retardant components include coated APP, which is well known as described in, e.g., U.S. Pat. Nos. 6,291,068 (Wang et al.), 5,599,626 (Fukumura et al.), and 5,534,291 (Fukumura et al.), the disclosures of which are incorporated herein by reference. A preferred melamine coated, APP fire retardant component for use in the present invention is commercially available from JLS Chemical Inc., Pomona, Calif., under the tradename JLS-APP101. This melamine coating has been found to enhance the flame retardancy properties of phosphate-based compounds used in the fire retardant system of the invention. A preferred silicone coated, APP fire retardant component for use in the present invention is commercially available from JLS Fire retardants Chemical Inc., Pomona, Calif., under the tradename JLS-APP102. An embodiment of a fire retardant system contemplated herein includes a phosphorus constituent and a polymeric ethylene-urea condensation product as a nitrogen-containing synergist for the intumescent fire-retardant system, as described in U.S. Pat. No. 4,772,642 to Staendeke. An example of a non-halogen fire barrier additive that can be used as the fire retardant component of the present invention or in combination with fire retardants is the Ceepree line of ceramifying fire barrier additives from Ceepree Products Ltd, Cheshire, UK.

In another embodiment, preferred fire retardant components are graphite-containing materials, such as expandable graphite flake. Expandable graphite is commercially available from Nyacol Nano Technologies, Inc., Ashland, Mass., under the tradename NYACOL® NYAGRAPH and from Graftach, Cleveland, Ohio, under the tradename GRAFGUARD 220-80N.

Mixtures of intumescent fire retardant components are specifically contemplated. Additionally, in addition to the intumescent fire retardant component, the body may comprise one or more other fire retardant materials that operate by a mechanism different from intumescence. Examples of additional fire retardant components include the metallic oxides or hydroxides that contain water of hydration. Preferred metallic oxides or hydroxides include aluminum trihydride (ATH) and magnesium hydroxide, both of which provide fire retardancy from their inherent water content. Further examples of preferred additional fire retardant components include antimony trioxide and zinc borate.

The fire retardant component is present in the fire retardant body in an amount from about 55% to about 95% of the body by weight. In a preferred embodiment, the fire retardant component is from about 60% to about 90% of the body by weight.

The fire retardant body comprises a polymeric matrix. The polymeric matrix is prepared from any polymer that will support a dispersion of the fire retardant material as presently described. In an embodiment of the present invention, preferred polymers for use in the matrix include thermoplastic polyolefin (TPO), rubbers such as butyl rubber, ethylene polypropylene rubber (EPR), ethylene propylene diene monomer polymers (EPDM), poly vinyl chloride, epoxy, polyurethane (such as Millathane® 66 PU polyurethane from TSE Industries, Inc, Clearwater, Fla.), polyurea, polyester, silicone rubber or gum, and copolymers and blends thereof. In another embodiment, the polymeric matrix comprises a polymer selected from the group consisting of ethylene polypropylene rubber, ethylene propylene diene monomer polymers, thermoplastic polyolefin, epoxy, polyurethane, polyurea, polyester, and copolymers and blends thereof.

In another embodiment the polymeric matrix comprises a polymer selected from the group consisting of ethylene polypropylene rubber, ethylene propylene diene monomer polymers, and copolymers and blends thereof.

In another preferred embodiment, the polymeric matrix is a thermoplastic vulcanate (TPV), such as described generally in U.S. Pat. No. 6,314,606. Examples of TPVs include those that consist of a mixture of polypropylene and EPDM (ethylene propylene diene monomers) which is available as SANTOPRENE™, described in U.S. Pat. No. 5,393,796 issued to Halberstadt et al, or VYRAM™, another TPV consisting of a mixture of polypropylene and natural rubber, both SANTOPRENE™ and VYRAM™ being elastomers marketed by Advanced Elastomer Systems. Other suitable elastomers include KRATON, a brand of styrene block copolymer (SBC) marketed by Shell, and DYNAFLEX G 2706™, a thermoplastic elastomer marketed by GLS Corporation and which is made with KRATON™ polymer.

In a preferred embodiment of the present invention, the polymeric matrix is crosslinked. Any suitable crosslinker may be used as appropriate for the polymer of the matrix. In an embodiment of the present invention, the polymer comprises unsaturated functionality, and a suitable crosslinker such as a sulfur crosslinker is used to provide the desired crosslinking. This embodiment may be less preferred because polymer having residual unsaturated functionality in the chain may be less stable under certain environments of use. Additionally, the use of sulfur as a component of the matrix may provide objectionable amounts of smoke and unpleasant odor when exposed to flame or high heat. In a preferred embodiment, the polymer may be crosslinked using a peroxide or other free radical initiated crosslinking system.

The fire retardant body can be provided in a number of material selections that can provide alternative and beneficial physical properties. Thus, in an embodiment, the fire retardant body is either soft or hard. In an embodiment of the present invention, the fire retardant body is relatively hard and has a Shore D hardness of from about 40 to about 70. Embodiments of the present invention that are relatively hard are particularly beneficial as providing reinforcing structure. In another aspect of this embodiment, relatively hard fire retardant bodies can provide durable protection against scraping or similar physical assaults. In another embodiment of the present invention, the fire retardant body is relatively soft and has a Shore A hardness of from about 25 to about 95, more preferably from about 45 to about 85. Relatively soft embodiments are beneficial in providing cushioning protection from impact and the like.

In embodiments of the present invention, the fire retardant body is either flexible, not flexible, or rigid. In an embodiment of the present invention, the fire retardant body is flexible, which is defined herein as being bendable to an angle of 45° preferably at a force less than about 300 g*cm, more preferably at a force of about 100 to about 240 g*cm, and most preferably at a force of about 150 to about 200 g*cm as measured by the Cantilever Bending Test (ASTM D5732). This embodiment is particularly beneficial in providing a material that can be readily flexed for positioning in the desired location. Thus, flexible fire retardant bodies can advantageously be easier to install when used as liners in confined spaces, when delivered in roll form for application at a work site, or when the ultimate application requires conformation of the fire retardant body to a structure, such as an I beam, architectural feature or the like.

In another embodiment of the present invention, the fire retardant body is not flexible, which is defined herein as requiring a force greater than 300 g*cm to bend to an angle of 45° as measured by the Cantilever Bending Test (ASTM D5732). In preferred aspects of this embodiment the fire retardant body requires a force greater than 500 g*cm or greater than 1000 g*cm to bend. This embodiment is advantageous in providing a stiff support structure, affording a reinforcement component to articles or structures to which the body may be attached. Alternatively, the non-flexible fire retardant body is advantageously self-supported.

In another embodiment, the fire retardant body is rigid, which is defined herein as being unable to be bent to an angle of 45° without breaking the fire retardant body. This embodiment advantageously provides stiff support to articles or structures to which the body may be attached. In an aspect of this embodiment, the non-flexible fire retardant body provides an article that is physically rigidly self-supported.

In another embodiment, the fire retardant body is elastic, having a Young's modulus of less than about 5 GPa, and more preferably less than about 1 GPa. An elastomeric fire retardant body of the present invention provides unique force absorbing properties in combination with the exceptional fire retardancy properties as discussed herein. Such fire retardant bodies find particular advantageous use in protection from blast damage. Additionally, the use of an elastic fire retardant body in construction applications can significantly enhance durability of the ultimate construction.

In an embodiment of the present invention, the fire retardant body is provided with a reinforcement material on one or more surfaces thereof, or optionally embedded within the fire retardant body. Preferably the reinforcement material is made from a refractory material, such as alumina-borosilicate fibers available as Nextel brand fibers from 3M Company of St. Paul, Minn. and other thermally resistant materials such as reinforced carbon-carbon fibers, silica fibers, alumina fibers, ceramic fibers and combinations thereof. Such heat resistant reinforcement is beneficial in preserving the char structure generated when the fire retardant body is exposed to heat and/or flame. This is helpful for optimal performance of the fire retardant body, because the char structure is fragile and is easily displaced under windy or friction conditions. In the case of severe fire conditions, conventional intumescents may not provide adequate protection, because forces such as air flow will disrupt the char structure of the fire retardant body when exposed to fire, thereby exposing surfaces to heat and flame. Thus, the embodiment comprising a reinforcement material in or on the fire retardant body provides even more improved protection from fire.

In one embodiment, the reinforcement material is in the form of a continuous sheet material. In another embodiment, the reinforcement material is a non-continuous sheet material such as a perforated sheet or web material. Such a non-continuous sheet material is particularly desirably as an embedded reinforcement material, because it provides bridges of continuous contact of the fire retardant body throughout the structure, thereby discouraging delamination or separation of the fire retardant body matrix from the reinforcement material. In a particularly preferred embodiment, the reinforcement material is a woven or non-woven fabric made from natural or synthetic fibers.

The fire retardant body may optionally comprise fillers, colorants, ultraviolet light absorbers, fungicides, bactericides, dyes, pigments, aluminum flakes, biocides, and other such additives suitable for incorporation into the fire retardant body as will now be appreciated by the skilled artisan.

Useful fillers include organic and/or inorganic filler. Exemplary inorganic fillers include sand, titania, clay, silica, fumed silica, combinations thereof, etc. Exemplary organic filler includes PVC, polystyrene, polypropylene, polyethylene, other olefinic fillers, combinations thereof, and the like. Preferred fillers include polyolefinic material such as polyethylene beads and/or polypropylene beads. Polyolefinic beads are lightweight and help provide cured compositions with high chemical resistance and high abrasion.

Suitable pigments include titanium dioxide, phthalocyanine blue, carbon black, basic carbonate white lead, zinc oxide, zinc sulfide, antimony oxide, zirconium oxide, lead sulfochromate, bismuth vanadate, bismuth molybdate, combinations thereof, etc.

Preferably, the fire retardant body of the present invention has a total halogen content of less then about 1500 ppm. Additionally, preferably the fire retardant body of the present invention has a total heavy metal content of less then about 1500 ppm. This very low content of halogen and/or heavy metal provides a body that is considered to be substantially free of halogen and/or heavy metal, and provides exceptional benefit from a public health standpoint in manufacture, usage and disposal of the fire retardant body. Most importantly, the fire retardant body meeting these maximum content standards does not release harmful amounts of these undesirable materials while functioning under fire conditions.

In an embodiment of the present invention, the fire retardant body can be provided with a metal layer (e.g. metal cladding) on one or more surfaces thereof. The fire retardant body may optionally also be provided in the form of a plurality of layers, with the layers having the same or different chemical constitution. The fire retardant body may be provided with an additional topcoat for protective or aesthetic purposes. Examples of topcoat compositions include urethane or silicone topcoat materials.

The fire retardant body is provided in a dimension suitable for use in protecting structures and/or articles. Thus, the fire retardant body preferably has a thickness of at least about 3 mm in each dimension. In other embodiments, the fire retardant body is provided with a greater thickness, i.e. having a thickness of at least about 5 mm or at least about 10 mm in each dimension.

In an embodiment of the present invention, the fire retardant body is provided in the general shape of a tile. In an embodiment, the body has a thickness of at least about 3 mm in a first dimension, and greater than about 10 cm in the second and third dimensions, with no dimension greater than about 500 cm, more preferably with no dimension greater than about 300 cm, and most preferably no dimension greater than about 50 cm. In an embodiment, the body has a thickness of from about 3 mm to about 500 mm in a first dimension, and greater than about 10 cm in the second and third dimensions, with no dimension greater than about 500 cm, more preferably with no dimension greater than about 300 cm, and most preferably no dimension greater than about 50 cm. In an embodiment, the fire retardant body has a thickness of from about 5 mm to about 300 mm in a first dimension, and greater than about 10 cm in the second and third dimensions, with no dimension greater than about 500 cm, more preferably with no dimension greater than about 300 cm, and most preferably no dimension greater than about 50 cm.

The present fire resistant bodies when provided in the form of a tile are particularly advantageous for use, because they can be installed in almost all locations and applications, from a simple flat surface to complex structural and building shapes. These tiles can, for example, be applied on floors, walls, ceilings, roofs and any other structures. In an embodiment of the present invention, complex shapes can be protected by first providing a carrier surface conforming to the desired shape, and mounting the present tiles thereon by conventional tiling techniques. The carrier surface can be provided by any type of construction materials such as thin steel sheets, plywood, dry wall, aluminum sheets, false ceiling, gypsum board, foam, polystyrene and similar materials. Preferably the tiles are mounted to the intended structure by a fire and/or heat resistant adhesive or cement product.

In an embodiment of the present invention, the fire retardant body is provided in a general shape suitable for use to contain girders or other support structures. In this embodiment, the body has a thickness of at least about 3 mm, or about 3 mm to about 500 mm, about 5 mm to about 300 mm as discussed above. The lengths of the other dimensions are determined by the structure to be contained. Optionally, more than one piece can be used to contain the structure. Optionally, the fire retardant body is provided in a non-planar configuration, i.e. having bends or comers. In the non-planar configuration, the dimensions are determined on a linear basis with the narrowest dimension being the thickness, and other dimensions determined as if bends or curves were removed to form a corresponding planar configuration.

In another embodiment of the present invention, the fire retardant body may be provided in the size of standard sheet building materials, such as drywall or plywood. For example, the fire retardant body may be provided in sizes of conventional gypsum drywall sizes (i.e. 4 ft×8 ft, 4 ft×9 ft, 4 ft×10 ft and 4 ft×12 ft, all in thicknesses of from about ⅛ inch, ¼ inch, ½ inch, or 1 inch in the US (with all combinations of the foregoing length, width and thickness measurements being specifically contemplated); and in similar size dimensions in other regional markets). Fire retardant bodies are specifically contemplated having a thickness of from about 3 mm to about 500 mm, width dimensions of from about 90 cm to about 160 cm, and length dimensions of from about 90 cm to about 400 cm. Fire retardant bodies of these sizes are particularly useful in wall, floor, ceiling or other construction applications.

Optionally, the fire retardant body can be provided with irregular dimensions.

In one embodiment of the present invention, the fire retardant body is affixed or placed adjacent to one side of an article, structure or space to be protected. In another embodiment, the fire retardant body is affixed or placed adjacent to a plurality of sides of an article, structure or space to be protected. In another embodiment, the fire retardant body is affixed or placed on all sides of an article, structure or space to be protected, thereby encapsulating the article, structure or space to be protected.

In another embodiment of the present invention, the fire retardant body can be form on or around a support structure or an article or material to be protected, thereby partially or completely encasing or encapsulating the support structure or an article or material to be protected. In a specifically contemplated embodiment, the fire retardant body encases a wire material such as electrical wiring, communication wiring or cable, optical fibers, or structural support wiring, cable, chains or rods. In a preferred embodiment, the fire retardant body is extruded onto the support structure or an article or material to be protected.

The fire retardant body is prepared by any suitable method now apparent to the artisan, such as by extrusion, coextrusion, casting, molding (including injection molding), or by other formation processes. The fire retardant component is dispersed in the polymeric matrix of the fire retardant body by any suitable method now apparent to the artisan, such as by premixing the fire retardant component with the polymer or a polymer precursor prior to body formation, or mixing during formation of the fire retardant body.

As noted above, the fire retardant body provides superior protection against potentially devastating fire situations in building construction and in other environments where fire and excessive heat that would lead to fire is a concern.

In a preferred embodiment, the fire retardant body is installed as fire barrier around a structure, partially or fully encasing or encapsulating a material or article to be protected, a building support structure to be protected, or a space to be protected. Alternatively, the fire retardant body can be installed as a fire barrier on one side of a structure, such as a roof, ceiling, wall or floor.

In a preferred embodiment, the fire retardant body is provided as a flooring material, either in tile form or in roll form. Optionally, the fire retardant body is provided in the form of linoleum flooring material. Similarly, the fire retardant body can be provided as a roofing material, either in shingle form or in roll form for application to pitched roofs or flat roofs. In a preferred embodiment, the fire retardant body is provided as a wall material, either in roll form or in large sheet form as discussed above.

In a preferred embodiment, one side of the fire retardant body is provided with an aesthetically pleasing appearance by applying a design or image to one side. The design or image may optionally be provided by laminating, coating or otherwise providing a suitably decorative layer to the fire retardant body. In an embodiment of the present invention, granules may be applied to one side of the fire retardant body to provide a pleasing appearance. The granules are optionally colored, and optionally themselves may comprise a fire retardant component. This embodiment is particularly suited for use as roofing materials.

Another example for use of the fire resistant bodies of the present invention is in space vehicles that require reentry in the earth's atmosphere. In such vehicles, such as the Space Shuttle, the temperature of the vehicle at the time of reentry is very intense. Tiles on such vehicles can be advantageously formed using the fire retardant bodies of the present invention. Optionally, these tiles can be metal cladded.

The present invention revolutionizes the fire safe and fire rated construction of critical, high security and high risk facilities. Examples of locations where protection from fire damage is critical include computer chip manufacturing plants, highly sensitive biological research facilities, data storage, super computer protection, defense establishments, ammunition loaded ships and the like.

Typical high risk, high security and critical areas of applications include but are not limited to the following:
Double wall (very low temperature) storage tanks for flammable and hazardous materials such as liquefied natural gas, ethylene, ammonia, etc.
Spheres containing flammable and hazardous materials such as propane gas, natural gas, ethylene, propylene, hydrogen and similar chemicals
Storage tanks for flammable and hazardous materials such as oil, petroleum products and other chemicals
Pipe racks and equipment supports
Nuclear plants
Critical supporting structures and facilities
Major plant control rooms
Research facilities
Defense facilities
Ammunition storage rooms
Record storage rooms
Fire and earthquake proof data centers
Airport communication and control towers
Server and master computer control rooms
Banks strong rooms
Museums and archeological buildings
Ships control rooms
Submarines
Command facilities
Missile storage and launch facilities
Tunnels
Aircraft hangers
Spaceship
Fire exit corridors

### EXAMPLES

### Example 1

The fire retardant body is formed from a resin having the following composition:

| RAW MATERIAL | %(By weight) |
|---|---|
| PC-260(mixed) | 30 |
| Tinuvin-292 | 0.3 |
| Tinuvin-1130 | 0.1 |
| Disperplast1142 | 0.5 |
| Titanium Dioxide | 10 |
| APP-101 | 60 |

### Procedure for Making a Fire Retardant Body in the Form of a Tile:

Step 1: Apply Polyprime 2180 primer (available from Polycoat Products Company, Santa Fe Springs, Calif.) on a 12″×12″ sheet of aluminium foil.
Step 2: Allow the primer to cure until it becomes tackfree. Then place the primed foil in a 12″×12″ compression mold having a depth of ½ inch with the primed surface facing up.
Step 3: Formulate the resin according to the recipe above by mixing PC-260 with UV & Light stabilizer and dispersing agent. Then disperse titanium and APP-101 into the mixed material.
Step 4: Pour the mixed material onto the primed foil to make ¼″ thick plaque. Place a fiberglass fabric (J P Stevens Co.-New York; Style: Volan Finish #09786; 7.5 oz. boat and tooling fabric) on the plaque.

Step 5: Pour another ¼″ thick material on top of the fiberglass and compress with an aluminum foil covered top plate to the level of the mold. Leave the compressed mold for overnight cure at ambient temperature.

Step 6: Leave the completed tile for 24 hours @130° F. for post cure.

### Burning Test:

### Test Parameters

Burner used: Benzomatic Propylene torch
Distance of burner tip from sample: 3 inch
Distance of burner tip from ground: 2 inch
Slope on which sample kept: Vertical
Temp. during the test—approx. 1300° F. to 1600° F. (though max. temperature attained was 1957° F., slightly away from the center).

| Time(min.) | Temperature(° F.) at the back of the tile |
|---|---|
| 1 | 73 |
| 3 | 83 |
| 4 | 92 |
| 5 | 93.4 |
| 6 | 100 |
| 7 | 108 |
| 8 | 111.6 |
| 9 | 113 |
| 10 | 120 |
| 15 | 149 |
| 30 | 210 |

After 30 minutes the test was stopped.

It was observed that a charred structure formed after 2-3 minutes of exposure to the flame. The smoke was white during burning the sample. The fiberglass fabric was observed to help in resisting flame spread and temperature rise at the back of the tile. The above test was repeated with an acetylene torch, which provides a hotter flame and increased force on the surface of the tile due to air flow. The fire was observed to burn through the tile within 2-3 minutes because of the force and temperature of the flame.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

What is claimed is:

1. A fire retardant body comprising a polymeric matrix comprising a non-halogenated fire retardant component that is an intumescent material, the fire retardant component being from about 55% to about 95% of the body by weight.

2. The fire retardant body of claim 1, wherein the body has a thickness of at least about 3 mm in each dimension

3. The fire retardant body of claim 1, wherein the body has a thickness of at least about 5 mm in each dimension.

4. The fire retardant body of claim 1, wherein the body has a thickness of at least about 3 mm in a first dimension, and greater than about 10 cm in the second and third dimensions, with no dimension greater than about 500 cm.

5. The fire retardant body of claim 1, wherein the fire retardant body has a thickness of from about 5 mm to about 300 mm in a first dimension, and greater than about 10 cm in the second and third dimensions, with no dimension greater than about 50 cm

6. The fire retardant body of claim 1, wherein the body has a thickness of from about 3 mm to about 500 mm, width dimensions of from about 90 cm to about 160 cm, and length dimensions of from about 90 cm to about 400 cm.

7. The fire retardant body of claim 1, wherein the fire retardant body is flexible.

8. The fire retardant body of claim 1, wherein the fire retardant body is not flexible.

9. The fire retardant body of claim 1, wherein the fire retardant body is rigid.

10. The fire retardant body of claim 1, wherein the polymeric matrix comprises a polymer selected from the group consisting of thermoplastic polyolefin (TPO), rubbers such as butyl rubber, ethylene polypropylene rubber (EPR), ethylene propylene diene monomer polymers (EPDM), poly vinyl chloride, epoxy, polyurethane, polyurea, polyester, silicone rubber or gum, and copolymers and blends thereof.

11. The fire retardant body of claim 1, wherein the polymeric matrix comprises a polymer selected from the group consisting of ethylene polypropylene rubber, ethylene propylene diene monomer polymers, thermoplastic polyolefin, epoxy, polyurethane, polyurea, polyester, and copolymers and blends thereof.

12. The fire retardant body of claim 1, wherein the polymeric matrix is a thermoplastic vulcanate.

13. The fire retardant body of claim 1, wherein the body has a Shore D hardness of from about 40 to about 70.

14. The fire retardant body of claim 1, wherein the body has a Shore A hardness of from about 25 to about 95.

15. The fire retardant body of claim 1, wherein the fire retardant component is from about 60% to about 90% of the body by weight.

16. The fire retardant body of claim 1, wherein the fire retardant body has a Young's modulus of less than about 5 GPa

17. The fire retardant body of claim 1, wherein the body comprises a reinforcement material embedded in the body.

18. The fire retardant body of claim 1, wherein the body comprises a reinforcement material on a surface of the body.

19. A method for protecting an article, structure or space from fire damage, comprising
a) providing a fire retardant body of claim 1,
b) installing the body as fire barrier adjacent or affixed to at least one side of an article, structure or space to be protected.

20. A method for protecting an article, structure or space from fire damage, comprising
a) providing a fire retardant body of claim 1,
b) installing the body as fire barrier adjacent or affixed to all sides of an article, structure or space to be protected, thereby encapsulating the article, structure or space to be protected.
